(19) United States
(12) Patent Application Publication
(10) Pub. No.: US 2023/0400277 A1
(43) Pub. Date: Dec. 14, 2023

(54) HAPTIC SYSTEM FOR A FIREARM SIMULATOR

(71) Applicant: Haptech, Inc., New Orleans, LA (US)

(72) Inventor: Kyle Monti, Luling, LA (US)

(21) Appl. No.: 17/824,747

(22) Filed: May 25, 2022

(51) Int. Cl. F41A 33/06

(52) U.S. Cl. CPC F41A 33/06

(57) ABSTRACT

A haptic effect system for generating haptic effects includes components that are configured to be mounted to an actual firearm. Elements of the haptic effect system are configured to occupy at least a part of the space that would otherwise be occupied by elements of the actual firearm. The haptic effect system converts an actual firearm capable of firing live ammunition into a firearm simulator. The haptic effect system generates haptic effects that cause a user holding the firearm to feel forces that mimic or simulate what a user would feel when performing various actions with the firearm. The haptic effect system can cause a user to feel forces that simulate what a user would normally feel when cocking the firearm, pulling a trigger of the firearm and/or shooting the firearm.

### BACKGROUND OF THE INVENTION

The invention is related to firearm simulators, and more specifically, to a haptic effect system that can be easily installed on an actual firearm to convert the firearm to a firearm simulator. Elements of the haptic effect system are configured to be installed within an actual firearm and to occupy at least a part of the space that would otherwise be occupied by elements of the actual firearm. The haptic effect system is configured to generate haptic effects that cause a user holding the firearm incorporating the haptic effect system to feel forces that mimic or simulate what a user would feel when performing various actions with an actual firearm in its original configuration. The haptic effect system can cause a user to feel forces that simulate what a user would feel when cocking the firearm, pulling a trigger of the firearm and/or shooting the actual firearm. The haptic effect system can also be easily uninstalled to restore the actual firearm back to its original functionality.

### BRIEF DESCRIPTION OF THE DRAWINGS

FIG. 1 is a diagram of elements that can make up a haptic effect system configured to be mounted on a firearm;

FIG. 2 is a diagram illustrating an M4 firearm, with elements of the firearm removed for display purposes;

FIGS. 3A and 3B illustrate a haptic generator that can be part of a haptic effect system to be mounted on a firearm;

FIG. 4 illustrates a controller module that can be part of a haptic effect system to be mounted on a firearm;

FIG. 5 illustrates a printed circuit board assembly that can be part of a controller module of a haptic effect system to be mounted on a firearm;

FIGS. 6A and 6B illustrate how a haptic effect generator and a controller module that are part of a haptic effect system can be joined together after being installed in a firearm;

FIG. 7 illustrates how a power supply of a haptic effect system can be installed on a firearm so as to interface with a processor module that is installed on the firearm;

FIGS. 8A and 8B illustrate details of printed circuit boards that can be part of a haptic effect system that is to be mounted on a firearm;

FIGS. 9A and 9B illustrate how sensors of a haptic effect system mounted on a firearm can obtain information about operating conditions on the firearm.

### DETAILED DESCRIPTION OF PREFERRED EMBODIMENTS

The disclosed technology is used to convert an actual firearm into a firearm simulator. To make the conversion, elements of the actual firearm are removed, and elements of a haptic effect system are installed in the locations that were previously occupied by the removed elements of the actual firearm. Often the elements of the actual firearm that are removed are hidden or internal elements. As a result, in many cases the firearm retains its overall appearance and feel. This contributes to realism when the converted firearm simulator is used in training exercises.

Of course, in some instances the elements of the haptic effect system may be installed on the firearm at locations that were not previously occupied by a removed element of the actual firearm. Also, an element of the haptic effect system installed on the firearm may be visible to the user. In such cases, the installation of one or more elements of the haptic effect system in or on the actual firearm may alter the look and feel of the firearm.

Certain elements of the haptic effect system are designed to cause the firearm to provide tactile feedback that closely simulates what a user would feel when conducting regular operations with the actual firearm. This can include providing tactile or haptic feedback when a user cocks the converted firearm simulator in preparation for firing, when the user actuates a trigger mechanism of the converted firearm simulator, or when the user “fires” the converted firearm simulator. For example, the haptic effect generated when the user “fires” the converted firearm simulator would be designed to mimic the recoil that a user would feel upon firing the actual firearm. The haptic effect could be selectively varied to simulate various different recoil forces that a user would experience upon firing different types of ammunition with the actual firearm.

The haptic effects can simulate safe, semiautomatic, fully automatic or burst fire modes, as well as non-traditional firing modes. Haptic effects can also simulate what a user might feel upon firing the last available round of ammunition, or what a user might feel upon the occurrence of a malfunction, such as a failure to feed, a failure to eject, a runaway condition, or a failure to fire. In all instances, because the user is operating an actual firearm that has been converted into a firearm simulator, the user experiences a high degree of realism during such simulated operations.

As will be explained in greater detail below, converting an actual firearm into a firearm simulator typically involves replacing some of the elements of the actual firearm with alternate mechanisms that will enable the converted firearm simulator to be used for simulated firing or training. The elements of the actual firearm that are removed can vary depending on the firearm and/or depending on the firearm simulator equipment that is to be installed.

For example, in some instances the hammer and trigger mechanism of the actual firearm will remain. As a result, during simulated operations cocking the firearm would still involve loading the firing mechanism such as a hammer or spring against the action of a spring element. Likewise, when the firearm simulator is fired, the user pulls the actual trigger of the firearm and the hammer would fall under the action of the loaded spring. All of these actions contribute to a realistic feel when the firearm simulator is being used. Of course, some installed elements such as a linear motor may provide the recoil force one expects upon firing the firearm simulator. Also, to the extent some forces are not present because no live round of ammunition is being fired, such as the hammer striking an inert firing pin or a firing pin striking an inert, “dummy”, or training round of ammunition, the feel of those actions may also be provided by one or more of the elements that have been installed on the actual firearm to convert the actual firearm into a firearm simulator.

Also, certain actions such as cocking the firearm may take on alternate meanings depending on how the firearm simulator is configured after it has been converted into a firearm simulator. If elements of the original firing mechanism remain after conversion, such as a charging handle, a spring, a hammer and a firing pin, then “cocking” the firearm simulator can involve causing all of those original elements to perform their normal actions as when the firearm simulator is cocked. However, if some of the original elements of the actual firearm that are involved in cocking the firearm are removed and replaced with other elements during conversion, then “cocking” the firearm simulator may involve the actions of those added items. For example, pulling a charging handle may not operate against an original spring of the actual firearm. Instead, pulling the charging handle may move an actuator or movable member of an added linear motor, with the linear motor providing force feedback designed to simulate what a user would feel when pulling the charging handle of an actual firearm.

Before explaining how an actual firearm can be converted into a firearm simulator, we first provide an overview of typical elements of a haptic effect system which can be used to convert an actual firearm into a firearm simulator. The following description discusses typical elements of a haptic effect system. However, the following description is in no way intended to be limiting. Haptic effect systems with elements in addition to those discussed below are possible. Also haptic effect systems having fewer than all of the items discussed below are possible, and likely would be quite common.

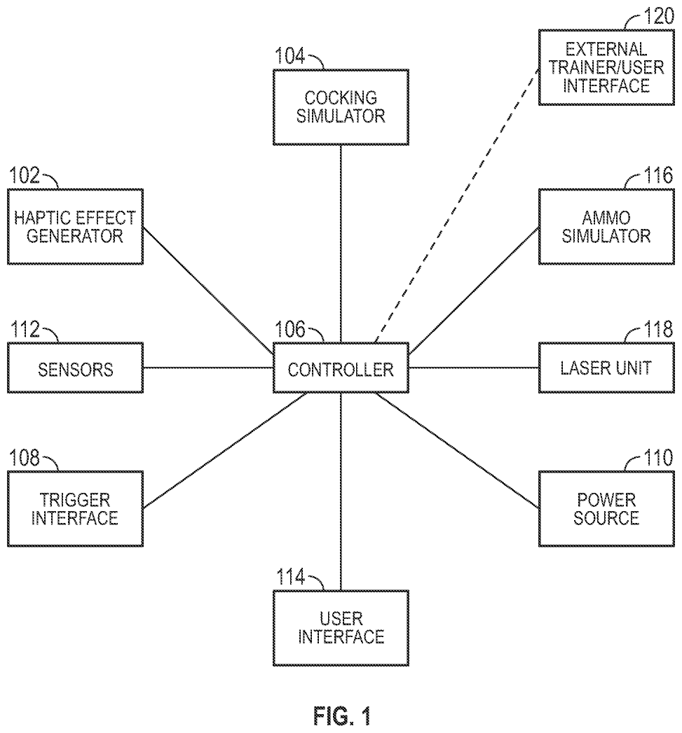

FIG. 1 illustrates typical elements of a haptic effect system 100 that can be installed on an actual firearm to convert the firearm into a firearm simulator. One of the key items is a haptic effect generator 102 that generates haptic effects. The haptic effect generator 102 could include one or more linear motors, eccentric weight vibrators, regular rotational electric motors, voice coils, solenoids, piezoelectric actuators, ultrasonic actuators and/or pneumatic or hydraulic actuators. The haptic effect generator 102 could include mixtures of those elements that are selected for the particular haptic effects they can provide. For example, an embodiment of a haptic effect generator 102 could include both a linear motor and a piezoelectric actuator, which together are capable of delivering various combinations of haptic effects.

In some embodiments, two or more linear motors could be included in the haptic effect generator 102, with the axes of the two linear motors oriented in different directions. By selectively actuating only one of the linear motors, or both of the linear motors, such a haptic effect generator 102 could generate haptic effects that simulate multiple different actions.

U.S. patent application Ser. No. 14/951,961, filed Nov. 25, 2015, which issued as U.S. Pat. No. 10,852,093 on Dec. 1, 2020, discloses technical details about how a linear motor can be configured and controlled to generate haptic effects that simulate the recoil forces that occur when a user fires an actual firearm. The disclosure of U.S. patent application Ser. No. 14/951,961 is incorporated herein by reference in its entirety.

The physical form and dimensions of the haptic effect generator 102 can be varied to enable the haptic effect generator 102 to be mounted within various different actual firearms. In some instances, such as where the haptic effect generator 102 is to be mounted inside a relatively large rifle, a haptic effect generator 102 with relatively large dimensions could be employed. In other instances, such as where the haptic effect generator 102 is to be installed within a relatively small handgun, the haptic effect generator 102 could have very small dimensions.

The haptic effect that is provided by the haptic effect generator 102 could also take many different forms. One of the primary uses of the haptic effect generator 102 is to simulate the recoil that a user will feel upon firing a firearm. This can include a single recoil associated with single shot fire, and multiple successive recoils associated with burst firing mode, or automatic fire.

Because a converted firearm simulator can be used in training, it also may be advantageous to have the haptic effect generator 102 simulate the feel of various malfunctions. Thus, a haptic effect generator 102 may generate a haptic effect to simulate the feel of a failure to fire or what it might feel like to fire a round of partially defective ammunition where the full recoil effect is not achieved. The haptic effect generator 102 might also simulate the feel of a jam or a failure to load a new round of ammunition from a magazine, or instances where a casing of spent ammunition jams during ejection from the firearm. Thus, the haptic effect generator 102 may be controlled to produce haptic effects that simulate a variety of different malfunctions.

The haptic effect generator 102 might also generate haptic effects that are not possible with an actual firearm, but which are interesting or useful for training purposes. As but one example, if a haptic generator 102 is coupled to a trigger mechanism of a converted firearm simulator, the haptic effect generator 102 could cause the user to feel a particular haptic effect that varies as the user applies greater and greater force to the trigger mechanism. For example, the trigger could vibrate, and the frequency and/or amplitude of vibration could steadily increase as the user applies greater and greater force to the trigger. Or, perhaps the opposite, where the frequency and/or amplitude of vibration starts out high and steadily decreases as more and more force is applied to the trigger until the vibration ceases just as the user applies sufficient force to the trigger to cause the firearm simulator to “fire.” Such haptic effects could be useful in training a user as to how much pressure need be applied to cause the firearm to fire.

Similarly, the haptic effect generator 102 could be configured such that it requires the user to apply varying amounts of pressure to a trigger to cause the firearm simulator to fire. This would allow a user to experience different trigger pull weights, and possibly allow a user to identify or choose a trigger pull weight that is desirable to the user.

The haptic effect generator 102 may also be under the control of a trainer, who causes the haptic effect generator 102 to selectively vary one or more haptic effects that the user experiences as part of an overall training program. The trainer could be a human or a software-based trainer. In some situations, the trainer could be a computer or software assisted human trainer. In any event, the trainer could cause a wireless signal to be sent to the haptic effect generator 102 at a selected time during training to cause the converted firearm simulator to exhibit a malfunction condition. This would allow the trainer to choose when a malfunction occurs, which also would allow the trainer to carefully observe how a user deals with the malfunction condition.

Thus far, we have discussed haptic effects relating to firing the firearm. However, a haptic effect generator 102 could be used in a variety of other contexts. For example, a haptic effect generator 102 such as a linear motor could be operatively coupled to a cocking mechanism of an actual firearm and the haptic effect generator could generate haptic effects relating to cocking the firearm. The haptic effect generator 102 coupled to the cocking mechanism of the firearm could be the same haptic effect generator 102 that provides recoil haptic effects, or a completely separate haptic effect generator 102 could be operatively coupled to the cocking mechanism of the firearm. Regardless, the haptic effect generator 102 could be controlled to provide a certain degree of force that resists movement of the cocking mechanism as the user actuates the cocking mechanism to prepare the firearm to be fired. The amount of force that the haptic effect generator 102 applies to the cocking mechanism could vary over the regular full course of movement of the cocking mechanism to simulate what a user would typically feel when cocking the actual firearm.

Also, here again, various malfunctions could be simulated. For example, the haptic effect generator 102 could be configured to apply forces to the cocking mechanism to simulate what a user would feel when there is a jam during the cocking movement. Also, if the ammunition magazine is empty when a user pulls on a cocking lever of a firearm to prepare the firearm for firing, there would be a different feel than what would occur when cocking the firearm loads a new round of ammunition into the firing position. Thus, the haptic effect generator 102 could apply forces to the cocking mechanism to simulate what it would feel like to cock the firearm without any ammunition in the firearm. This too would help a new user to understand what it feels like under various different operational conditions.

The haptic effect generator 102 could also simulate a variety of other actions of a firearm. For example, the haptic effect generator could generate forces that simulate what a user feels when a slide of semiautomatic handgun is released from the locked open position after loading a new magazine of ammunition into the firearm and when a new round of ammunition is loaded into the firing chamber. Similarly, in the case of a semiautomatic shotgun, the haptic effect generator 102 could generate forces that simulate what a user feels when the action is released after manually loading a new shell into the shotgun as the shell is moved into the firing chamber.

As mentioned above, the same haptic effect generator 102 that provides a recoil haptic effect also may be operationally coupled to a cocking mechanism of the firearm such that the haptic effect generator 102 can apply forces to the cocking mechanism. However, in alternate embodiments there may be a separate cocking simulator 104 that is operationally coupled to the cocking mechanism of the firearm. The cocking simulator 104 also may employ one or more linear motors, eccentric weight vibrators, regular rotational electric motors, piezoelectric actuators, voice coils, solenoids, ultrasonic actuators and/or pneumatic or hydraulic actuators. In some firearms, it may be necessary to provide a separate cocking simulator 104 to apply forces to the cocking mechanism of the firearm as a haptic effect generator 102 that provides appropriate recoil forces may be unable to interact with the cocking mechanism of the firearm. Such a separate cocking simulator 104 would be capable of providing all the forces detailed above to provide to the user the feel of cocking the firearm under regular and malfunction conditions.

A cocking simulator 104 could apply forces to a cocking mechanism of a firearm according to a force vs. displacement profile. The cocking mechanism 104 could also generate and apply forces to the cocking mechanism of the firearm to simulate what a user would feel when moving the cocking mechanism to an open and locked position. For example, the cocking simulator could provide forces so that a user experiences what it feels like to move the action of a semiautomatic shotgun to the open and locked position, which allows a new shotgun shell to be inserted into the shotgun.

Both the haptic effect generator 102 and a cocking simulator 104, if provided, would receive control signals from a controller 106 of the haptic effect system 100. The controller 106 could be integrated into the same physical elements as the haptic effect generator 102 and/or the cocking simulator 104. Alternatively, the controller 106 could be a separate physical element that is mounted on or within the firearm. When the controller 106 is separate from other elements of the haptic effects system 100, the controller 106 could communicate with the other elements via a wired or wireless connection. For example, typical wireless Bluetooth connections could be established between the controller 106 and one or more other elements of the haptic effect system 100. The controller 106 could both receive signals from the other elements and provide control signals to the other elements.

In still other instances, the controller 106 might be located apart from the body of the firearm. In that instance, the controller 106 could communicate with elements of the haptic effect system 100 mounted on the firearm via a wired or wireless connection.

The haptic effect system 100 also includes a trigger interface 108. The trigger interface could take many different forms, depending on the configuration of the firearm itself. At its core, the trigger interface 108 is designed to determine when a user actuates the trigger mechanism of the firearm. The trigger interface 108 sends a trigger signal to the controller 106 when the trigger interface 108 determines that the user has actuated the trigger mechanism of the firearm.

The firearm itself may be capable of operating under multiple firing modes. Often an actual firearm will have firing modes that include safe, single shot or semiautomatic, burst and fully automatic. A firearm simulator incorporating a haptic effect system 100 may be configured to simulate some or all of those firing modes. In some instances, a selector switch on the firearm will determine which firing mode under which the firearm is operating. In instances when the firearm is capable of operating in a fully automatic firing mode, the trigger interface 108 is capable of generating and sending signals to the controller 106 to indicate that the user is holding the trigger down to cause fully automatic fire.

The trigger interface 108 may also apply a force to the firing mechanism of the firearm that helps to simulate what a user would feel when pulling the trigger of the firearm. The trigger interface 108 may include a device such as one or more linear motors, eccentric weight vibrators, regular rotational electric motors, piezoelectric actuators, voice coils, solenoids, ultrasonic actuators and/or pneumatic or hydraulic actuators. The force or forces applied to the trigger mechanism by the trigger interface 108 could vary the trigger pull to allow users to experience different trigger pull weights. Also, the trigger interface 108 could apply a force to the trigger mechanism that varies over the length of trigger travel to closely simulate what a user would feel as trigger of the firearm is pulled. A force vs. travel profile could be used to determine what force the trigger interface 108 applies to the trigger mechanism as the trigger moves through the full range of travel.

The trigger interface 108 could apply different forces to the trigger mechanism depending on the operational condition of the firearm. For example, one type of force could be applied to the trigger mechanism during a normal firing operation, whereas another force could be applied to the trigger mechanism when a user actuates the trigger mechanism when the firearm has already expended all available ammunition.

In some instances, a trigger interface 108 is designed to interface with the existing trigger mechanism of the firearm. In other instances, one of the original parts of the firearm that are replaced when the firearm is converted into a firearm simulator may include the trigger mechanism. In other words, the trigger interface 108 could include an entirely new trigger and trigger mechanism that replaces the original trigger and/or trigger mechanism of the firearm. A trigger interface 108 that includes a replacement trigger and/or trigger mechanism could also include an actuator that provides a force to the user's finger when the user is actuating the trigger to simulate what a user would typically feel when actuating the trigger mechanism.

The haptic effect system 100 also includes a power source 110 that provides power to other elements of the system. The power source 110 could include batteries, capacitors, super-capacitors and other energy storage devices that can be used to provide electrical power to other elements of the haptic effect system 100. In some instances, the power source 110 could be coupled to a continuous source of electrical power, as opposed to using an energy storage device.

In some embodiments, the power source 110 may be integrated into another element of the haptic effect system 100, such as being a part of a controller module 106. In other instances, the power source 110 may be a separate element that is mounted to or within the firearm. In some embodiments, the power source 110 may take the form of a replaceable unit that can be removed from the firearm for re-charging, and which can then remount to the firearm. For example, the power source 110 could be configured to resemble an ammunition magazine that can be swapped out just like a regular ammunition magazine of the firearm. In some embodiments, the power source 110 could be external to the firearm simulator. For example, the power source 110 could be an external stationary power source or a user-wearable power source that is wired to the firearm simulator.

In instances where the power source 110 is mounted to the firearm, the power source 110 could be attached to external power for recharging via an electrical charging cord. Alternatively, the power source 110 may have a built-in inductive charging port that need only be brought adjacent a corresponding inductive charging unit.

The power source 110 may be hard wired to other elements of the haptic effect system 100 to provide electrical power to those elements. Alternatively, the power source 110 may provide electrical power to other elements of the haptic effect system 100 via an inductive link. In the future, other means of delivering electrical power to the elements of the haptic effect system 100 or to the power source 110 may be possible, such as RF energy harvesting.

In some embodiments, such as where a replaceable unit like an ammunition magazine contains the main power source 110, a secondary power source may also be provided. The secondary power source could power the controller 106 and possibly other elements of the overall haptic effect system while a main replaceable power source 110 is removed from, recharged and then remounted to the firearm simulator. This would ensure that data currently being stored by one or more elements of the haptic effect system 100 can be retained while the main power source 110 is replaced or recharged.

The haptic effect system 100 can include one or more sensors 112 that are configured to sense various things and to provide information about sensed conditions to the controller 106 or to other elements of the haptic effect system 100. The information gathered by the one or more sensors 112 is then used to help control other elements of the haptic effect system 100 to provide the user with a useful and immersive experience.

In some instances, the sensors 112 of the haptic effect system 100 could sense the positions of various controls of the firearm. For example, a sensor 112 could detect the position of a fire control switch that is used to switch between safe, single fire or semiautomatic, burst and fully automatic firing modes. Information from the sensor 112 is sent to the controller 106 and the controller then controls the other elements of the haptic effect system to provide firing in the mode currently selected by the fire control switch.

As another example, one or more sensors 112 could be used to detect a position of a trigger mechanism of the firearm. Information from that sensor 112 is sent to the controller 106, which uses the information to determine when the user is actuating the trigger mechanism, and thus when to simulate firing the firearm.

A sensor 112 could detect when a magazine is properly mounted to the firearm. If such a sensor reports to the controller 106 that a magazine has been improperly mounted to the firearm, the controller could cause a malfunction condition to be performed. One or more sensors 112 could also detect the presence of one or more accessories mounted on the firearm simulator, such as a scope, an auxiliary lighting device, a grenade launcher, etc. Information about the configuration of the firearm simulator, as collected via the sensors 112, could be used to help control operations of the haptic effect system 100.

The sensors 112 could also include a variety of inertial and motion sensors that are configured to detect the current orientation of the firearm and when and how the user is moving the firearm. Such information could be reported to the controller 106, and/or to a gaming or simulation system that is completely separate from the firearm. The gaming or simulation system could use information reported from inertial and motion sensors 112 to help generate an augmented or virtual reality view that is then displayed to the user of the firearm.

The foregoing lists contain but a few of the many different types of sensors 112 that could be a part of a haptic effect system 100. Many other different types of sensors could also be used for various other purposes. Such sensors could communicate with the controller 106 or with elements completely separate from the haptic effect system 100 via a wired or wireless connection.

The haptic effect system 100 further includes a user interface 114. The user interface 114 can be used to show or display certain items of information to the user. Such information can include, for example, a number of shots fired or the amount of ammunition remaining in a magazine. Such information can also include current settings or configuration details, such as the currently selected firing pattern. This type of information could be displayed to a user via a small display screen or one or more indicators that are part of the user interface 114. Such a display or such indicators could be mounted to a convenient part of the firearm so that they can be easily seen by the user when holding the firearm in a normal manner.

The user interface 114 also provides a mechanism for receiving user input. Thus, the user interface could utilize a variety of different devices for receiving input from a user. In simple examples, the user interface 114 could include buttons or controls mounted on the firearm that allow a user to provide direct manual input. In some embodiments, a touch sensitive screen that is part of the user interface 114 could be used to both display information to the user and also receive input from the user via a graphical user interface. In some instances, the user interface also could include a microphone that receives spoken input from the user and which then interprets the spoken input via speech recognition techniques. In other instances, the user interface could also contain one or more connected cameras that enable gesture recognition or user identification.

In other embodiments, the user interface 114 could include a software program that runs on a computing device, such as a desktop or laptop computer, a tablet or smartphone and which allows a user to input various items of information as well as view various items of information. The software application on the computing device could communicate wirelessly or via a wired connection with the controller 106 of the haptic effect system 100.

The input that a user provides via the user interface 114 could include specifying a type of ammunition that the haptic effect generator 102 will use to simulate firing. The user input could also indicate the type and related characteristics such as size of an ammunition magazine that the firearm is to presume is present, which, for example, will dictate the number of rounds of ammunition that can be shot before reloading. The user input might also specify the trigger pull force that is to be provided by the trigger interface 108, or possibly specify a force vs. trigger pull distance profile that is to be used by the trigger interface 108.

The user interface might also be used to input things like how often the firearm is to simulate a malfunction, and the types of malfunctions that are to be simulated. This sort of input could be provided by a training instructor before passing the firearm simulator over to a student that is to use the firearm simulator as part of a training exercise.

A completely separate trainer/user interface 120 might also be capable of communicating with the controller 106 or other elements of the haptic effect system 100 via a wired or wireless connection. When the separate interface is a trainer interface 120, a trainer could use the trainer interface 120 to communicate all the above-listed items of information to the controller 106. Likewise, the trainer interface 120 could receive all the above-listed items of information from the controller 106. The trainer interface 120 could also communicate a variety of other items of information and control signals with the controller. For example, a trainer could use the trainer interface 120 to send control signals to the controller 106 that indicate when a haptic effect generator 102 or other elements of the haptic effect system 100 are to simulate a malfunction of some kind.

The separate trainer/user interface 120 could be capable of communicating with multiple haptic effect systems 100 mounted on multiple firearm simulators to thereby control a training exercise involving multiple firearm simulators. In the same fashion, a single external trainer/user interface 120 could receive data from multiple firearm simulators and correlate, manipulate or process that data. The external trainer/user interface 120 could then present raw, correlated or processed data, generate reports and otherwise provide various useful functionality to a trainer. When a single external trainer/user interface 120 is receiving reporting signals from multiple firearm simulators as part of a group training exercise, the external trainer/user interface 120 could provide a single consolidated display that summarizes the performance and status of all users in the training exercise.

The external trainer/user interface 120 could be a purpose-built device, or it could be configured as a software application running on a computing device such as a laptop computer or a smartphone. In some instances, the external trainer/user interface 120 could be incorporated into another firearm simulator, such as where a trainer has a master firearm simulator that controls one or more slave firearm simulators. The external trainer/user interface 120 could be located at the same premises as a firearm simulator that is communicating with the external trainer/user interface 120, or the external trainer/user interface 120 could be remote or cloud-based in nature.

The haptic effect system 100 may also include an ammunition simulator 116 that is designed to determine when a user fires the firearm. The ammunition simulator 116 is designed to be positioned where a round of ammunition would be located just prior to firing the firearm. The ammunition simulator 116 could include a sensor that is capable of detecting when a firing pin of the firearm contacts the back of the ammunition simulator 116. When the sensor registers a hit from the firing pin, the ammunition simulator 116 sends a firing signal to the controller 106, and the controller then causes a haptic effect generator 102 to generate a haptic effect that simulates firing of the firearm.

As an example, the ammunition simulator 116 could be configured as a shotgun shell that is inserted into a shotgun just before the shotgun is fired. When the user actuates the trigger mechanism and causes a firing pin of the shotgun to impact the back of the ammunition simulator 116, the ammunition simulator 116 sends a firing signal to the controller 106. The controller 106 then causes the haptic effect generator 102 to create a recoil effect to simulate firing of the shotgun. When an ammunition simulator 116 is used in this fashion, all of the mechanisms in the shotgun relating to firing the shotgun can be retained in their original condition to provide a very realistic firing effect for the user.

The haptic effect system 100 could further include a laser unit 118 that emits laser light. The laser unit 118 could be mounted in the firearm such that laser light is emitted down the barrel of the firearm towards whatever the firearm is pointed at. The laser light could be used both to aim the firearm, and also to hit laser detectors that register hits when the firearm is fired. Additionally, the laser could be mounted on the firearm and aligned with the barrel to aim the firearm, and also to hit laser detectors that register hits when the firearm is fired.

The laser unit 118 could communicate with the controller 106 via a wired or wireless link. If the laser light emitted from the laser unit is designed to help aim the firearm, then the laser unit 118 may be caused to emit laser light when the user pushes a separate aiming switch or when the trigger interface 108 indicates that the user has partially depressed the trigger of the firearm.

Alternatively, the laser unit 118 could be caused to emit laser light only when the user actuates the trigger of the firearm to take a shot. At that point, one or more detectors within a targeted area could sense the laser light emitted by the laser unit 118 to register a hit.

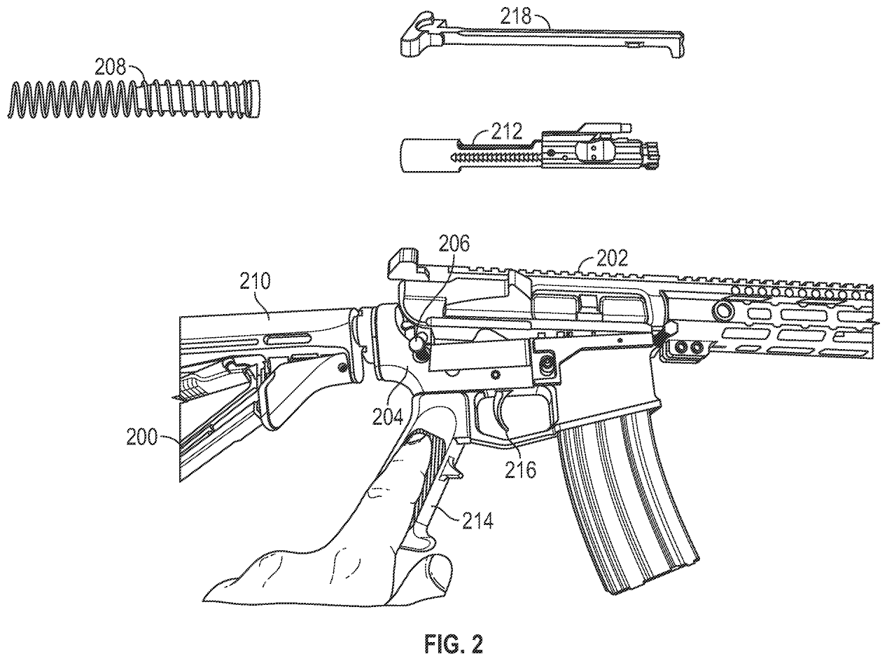

With the foregoing as background, we will now turn to an example of how elements of a haptic effect system 100 can be installed on an actual firearm to convert the firearm to a firearm simulator. For this example, the actual firearm will be an M4 rifle, such as the one depicted in FIG. 2.

An M4 rifle 200 can be partially disassembled without tools by pulling pins 206 on opposite sides of the rifle to allow an upper receiver 202 to separate from a lower receiver 204. Once opened in this fashion, one can remove a buffer spring assembly 208 from the stock 210 of the rifle 200. One can also remove a bolt carrier group 212 from the portion of the interior of the rifle 200 just above the grip 214 and trigger 216. Further, one can remove the charging handle 218 which normally sits above the bolt carrier group 212. Once those items have been removed from the rifle, elements of a haptic effect system are installed in the same locations to convert the actual M4 firearm into an M4 firearm simulator.

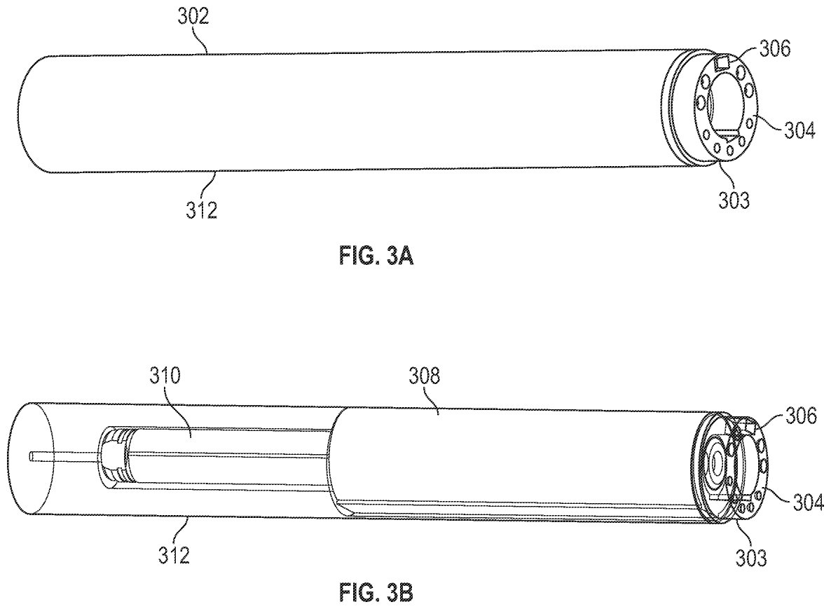

The first item of the haptic effect system that will be inserted into the M4 rifle is a haptic effect generator 302 which is configured to generate forces to simulate a recoil when the rifle is fired. As shown in FIGS. 3A and 3B, the haptic effect generator 302 includes a cylindrical outer housing 312. FIG. 3B presents a partially transparent view that shows that a linear motor formed from a stator 308 and a sliding mass 310 is located inside the cylindrical housing 312. A plurality of electrical coils (not shown) are located on the stator 308, and a plurality of permanent magnets (not shown) are mounted in the sliding mass 310. By selectively applying electrical signals to the coils of the stator 308 one can induce and control movements of the sliding mass 310 to generate various haptic effects, including recoil forces that simulate firing the rifle.

An interface 303 is provided at one end of the haptic effect generator 302. The interface includes a plurality of electrical contacts 304 that can be used to apply electrical signals to the coils of the stator 308. The electrical contacts 304 could also be used to communicate signals from one or more sensors that detect and report movements of the sliding mass 310 relative to the stator 308. The interface 303 also includes one half of a magnetic mount 306 that is used to removably join the haptic effect generator 302 to an electronics module with a controller, as will be described in more detail below.

The haptic effect generator is slid into the space within the stock 210 of the rifle 200 that previously held the buffer spring assembly 208. Because the sliding mass 310 of the linear motor is then aligned with the rifle barrel, movements of the sliding mass 310 can generate forces that simulate recoil effects.

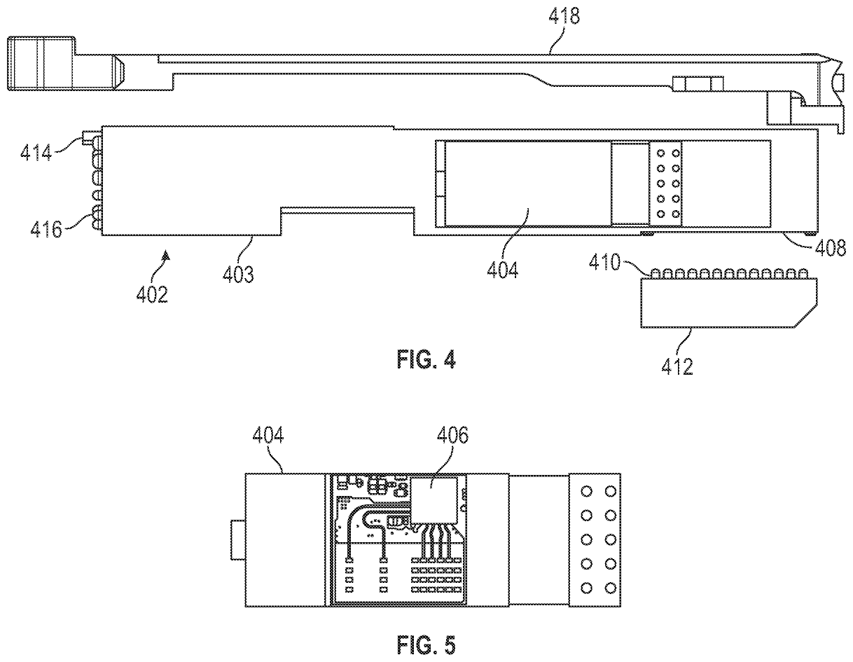

FIG. 4 illustrates an electronics module 402 that includes a generally cylindrical housing 403. A printed circuit board 404 that includes a controller that controls actions of the haptic effect system is mounted on the housing 403. Electrical contacts 408 are located on an underside of the housing 403. The electrical contacts 408 are configured to contact corresponding electrical contacts 410 on an electrical interface unit 412. As will be explained below, the electrical interface unit 412 is used to deliver electrical power to the electronics module 402.

The electronics module 402 is designed to be mounted in the space within the rifle 200 that was previously occupied by the bolt carrier group 212. Once the electronics module 402 is mounted in that location on the rifle 200, the left end of the electronics module is positioned immediately adjacent to the right end of the haptic effect generator 302, which has been mounted in the stock 210 of the rifle 200 where the buffer spring assembly 208 was previously located.

As illustrated in FIG. 4, electrical contacts 416 are located on the left end of the electronics module 402. Those electrical contacts 416 are designed to mate to the corresponding electrical contacts 304 on the right end of the haptic effect generator 302, as illustrated in FIGS. 3A and 3B. There is also a magnetic mounting device 414 on the left end of the electronics module 402 that is designed to be received in the magnetic mount 306 on the right end of the haptic effect generator 302.

FIG. 4 also illustrates a substitute charging handle 418 than can replace the original charging handle 218 of the rifle. As depicted in FIG. 4, the replacement charging handle 418 would still be located above the electronics module 402 within the interior of the rifle in a position that is basically identical to the position original charging handle 218 of the rifle 200.

FIG. 5 provides an enlarged view of the printed circuit board 404 of the electronics module 402. As shown in FIG. 5, a processor 406 mounted on the printed circuit board 404 actually controls the haptic effect system. As will be explained below, various other elements, including sensing technology elements may also be mounted on the printed circuit board 404.

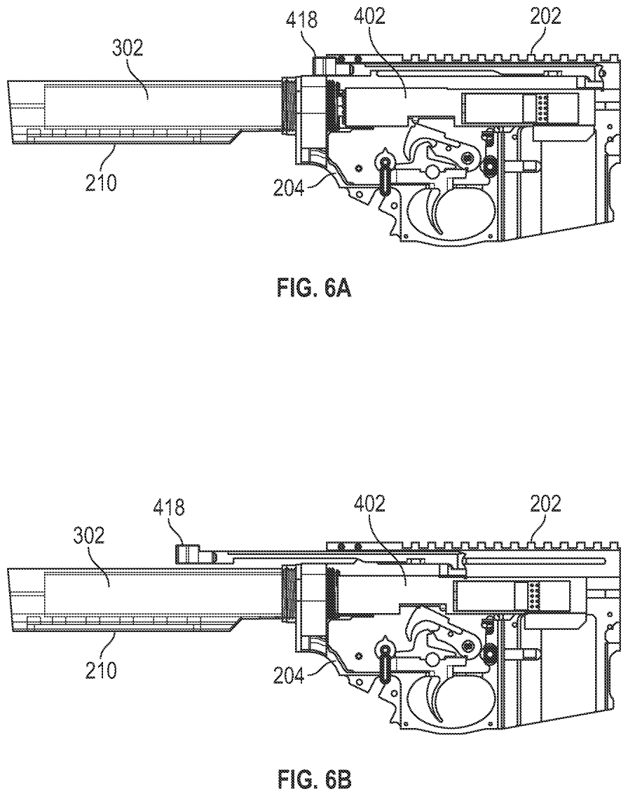

FIGS. 6A and 6B illustrate how the electronics module 402 is physically and electrically coupled to the haptic effect generator 302 once both of those items have been mounted within the rifle. FIG. 6A illustrates a condition in which the haptic effect generator 302 has been mounted in the stock 210 of the rifle 200, and in which the electronics module 402 has been located in the position previously occupied by the bolt carrier group 212 of the rifle 212. In addition, the charging handle 418 has been located above the electronics module 402. The upper receiver 202 of the rifle 200 has been re-joined to the lower receiver 204 of the rifle 200.

To couple the electronics module 402 to the haptic effect generator 302, the charging handle 418 is then pulled backward, as illustrated in FIG. 6B. This causes the left end of the electronics module 402 to contact the right end of the haptic effect generator 302. This, in turn, causes the magnet element 414 on the left end of the electronics module 402 to be received in the corresponding magnetic mount 306 on the right end of the haptic effect generator 302. The magnet mounting elements 306/414 then hold the electronics module 402 and the haptic effect generator 302 together.

In addition, the electrical contacts 416 on the left side of the electronics module 402 connect to corresponding ones of the electrical contacts 304 on the right side of the haptic effect generator 302. This makes it possible for the processor 406 on the printed circuit board 404 of the electronics module 402 to send control signals to the haptic effect generator 302 to cause the linear motor of the haptic effect generator 302 to generate recoil forces. This also allows sensors on the haptic effect generator 302 to send sensor signals to the processor 406.

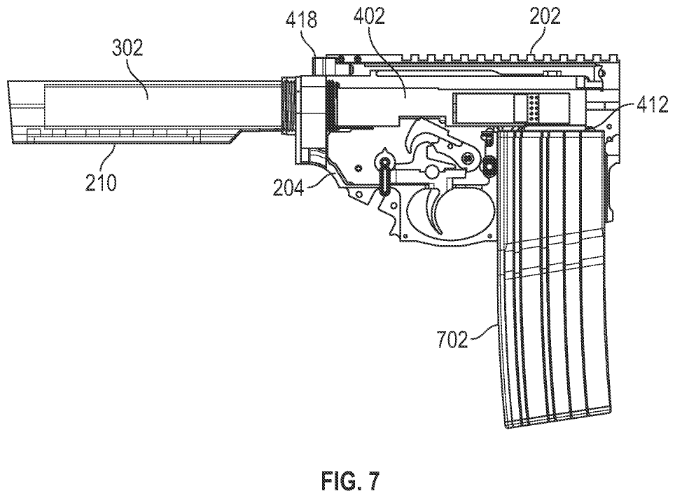

FIG. 7 illustrates how a power source 702 can be mounted to the rifle to provide power to the haptic effect system. As shown in FIG. 7, a power source 702 has a form that resembles an ammunition magazine that would be mounted to the rifle 200. The interior of the power source includes batteries, capacitors or some other form of electrical energy storage device. Electrical contacts are formed on the top surface of the power source 702, and the electrical contacts are designed to abut and mate with electrical contacts on the bottom of the electrical interface unit 412.

When the power source 702 is slid into the magazine receiving slot of the rifle 200, the electrical contacts on the top of the power source 702 mate with the electrical contacts on the bottom of the electrical interface unit 412. Also, upward movement of the power source 702 causes the electrical contacts 410 on the top of the electrical interface unit 412 to engage with corresponding electrical contacts on the bottom surface of the electronics module 402. As a result, power from the power source 702 is communicated to the printed circuit board 404 and the processor 406 on the electronics module. This electrical power can then be communicated through the electronics module 402 to the haptic effect generator 302 via the electrical contacts 416/304 that join the electronics module 402 to the haptic effect generator 302.

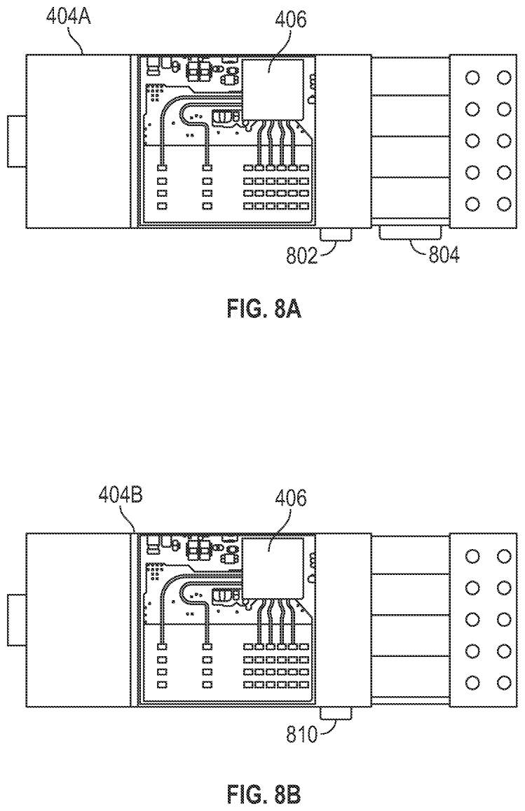

FIG. 8A illustrates a first embodiment of a printed circuit board 404A of the electronics module. In this embodiment, the printed circuit board 404A includes an electromagnetic emitter array 802 that emits electromagnetic radiation. The electromagnetic emitter array 802 is mounted to a first portion of the bottom edge of the printed circuit board 404. In addition, an electromagnetic detector array 804 that senses electromagnetic radiation is mounted on a second portion of the bottom edge of the printed circuit board 404.

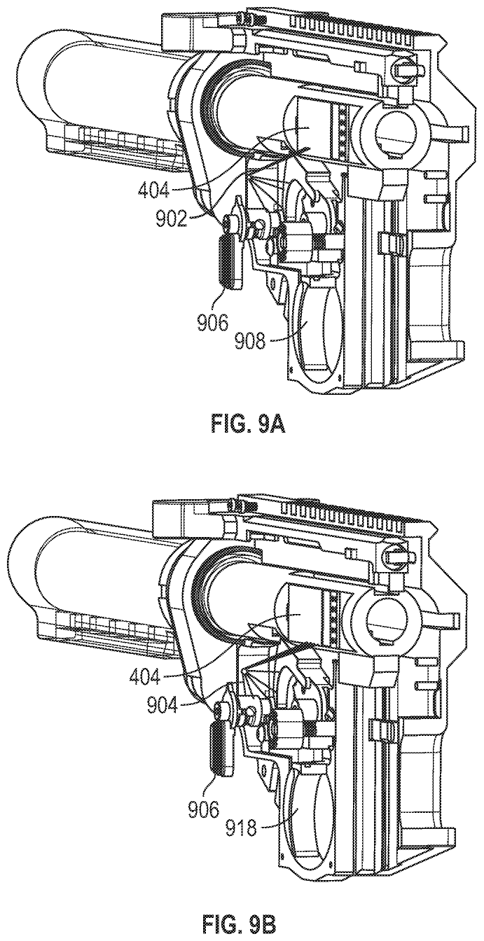

As illustrated in FIGS. 9A and 9B, electromagnetic radiation 902 emitted by the emitter array 802 on the printed circuit board 404A travels through the interior of the rifle and is reflected from various surfaces therein. Reflected electromagnetic radiation 904 is ultimately detected by the detector array 804 on the printed circuit board 404A. The detected electromagnetic radiation can provide information about the current positions and orientations of the elements within the rifle. Likewise, changes in the detected electromagnetic radiation can provide information about movements of elements of the rifle.

By analyzing the reflected electromagnetic radiation detected by the detector array 804 it may be possible to determine the configuration and movement of internal elements of the rifle, like the current position of the fire selector switch 906, or possibly the movement of the trigger 908. Thus, information derived from the detected electromagnetic radiation can be used to help control the haptic effect system.

FIG. 8B illustrates an alternate embodiment of the printed circuit board 404B which includes a consolidated “time-of-flight” sensor 810. A time-of-flight sensor 810 includes both a laser emitter and a two-dimensional laser detector array. A pulse of laser radiation emitted from the laser emitter reflects off of various elements within the firearm and the reflected laser radiation is then sensed by the laser detector array. The time of flight of the laser pulse from the emitter to each of the sensors in the detector array is used to determine the distance to various objects within the field of view of the emitter/detector pair. Here again, information derived from the time-of-flight measurements could be used to determine the positions and orientations of elements within the firearm, as well as movements of those elements. It is possible to determine when a trigger is pulled based on the signals from the time-of-flight sensor 810, and that information is then used to control the haptic effect system.

The examples of sensors provided above in connection with FIGS. 8A and 8B are but two examples of sensors that could be used to detect the positions of various mechanisms within the firearm and the movements of those mechanisms. Various other sensors and sensing technology could also be used in place of the sensors discussed above to detect the positions, orientations, movements and configurations of internal elements of a firearm. Thus, the foregoing discussion in connection with FIGS. 8A and 8B should in no way be considered limiting.

In operation, the processor 406 in the electronics module 402 would determine when the user pulls the trigger of the rifle, and the processor 406 would then send appropriate signals to the haptic effect module 302 to cause the haptic effect module to generate a recoil force.

Some or all of the elements of a haptic effect system 100 may be waterproof or water resistant such that a firearm simulator incorporating a haptic effect system can be used in wet or rainy conditions. Some or all of the elements of a haptic effect system 100 may also be shock hardened or resistant to other environmental elements such as heat, sand or other contaminants to ensure a firearm simulator incorporating the haptic effect system 100 can be used in a wide variety of operational conditions.

As noted above, a single firearm simulator may incorporate a haptic effect system 100 that includes multiple haptic effect generators 102. For example, a first haptic effect generator 102 could be used to generate recoil forces that simulate firing the firearm simulator, a second haptic effect generator 102 could generate forces applied to a cocking mechanism of the firearm simulator and yet a third haptic effect generator 102 could generate forces that are applied to a trigger mechanism of the firearm simulator. All three of those haptic effect generators 102 could be under the control of a single controller 106. Alternatively, a haptic effect system 100 could include multiple controllers 106 that each control one or more haptic effect generators 102.

A single firearm simulator might also incorporate multiple individual haptic effect systems 100. For example, a first haptic effect system 100 could be responsible for generating one or more haptic effects associated with cocking and firing the firearm simulator and a second haptic effect system 100 mounted on the same firearm simulator could be responsible for generating haptic effects associated with firing a grenade launcher that is also attached to the firearm simulator. When two or more haptic effect systems 100 are mounted on the same firearm simulator, the haptic effect systems 100 could communicate with one another and coordinate their actions.

In some instances, a haptic effect system 100 could comprise multiple individual modules that together provide a certain haptic effect functionality. For example, a first module of a haptic effect system 100 could replace a traditional bolt carrier group of a firearm and a second module of the haptic effect system 100 could replace a trigger module of the firearm. Each of the modules could communicate with one or more controllers of the haptic effect system 100 via wired or wireless communication paths.

The following detailed description of preferred embodiments refers to the accompanying drawings, which illustrate specific embodiments of the invention. Other embodiments having different structures and operations do not depart from the scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A haptic effect system configured to be mounted to a firearm, comprising:
a haptic effect generator configured to be removably attached to a firearm, the haptic effect generator being capable of generating a haptic effect that simulates firing the firearm;
a controller that is operatively coupled to the haptic effect generator and that causes the haptic effect generator to generate the haptic effect;
a trigger interface configured to be removably attached to the firearm, wherein the trigger interface is operatively coupled to a trigger of the firearm, and wherein the trigger interface causes a trigger signal to be sent to either the controller or the haptic effect generator when the trigger of the firearm is actuated; and
a power source that provides power to the controller and the haptic effect generator.

2. The haptic effect system of claim 1, wherein the haptic effect generator comprises a linear motor.

3. The haptic effect system of claim 1, wherein the haptic effect generator and the trigger interface are configured to be mounted internally within the firearm in locations that would otherwise be occupied by existing mechanisms of the firearm.

4. The haptic effect system of claim 1, wherein the controller is configured to generate and send firing signals to the haptic effect generator that cause the haptic effect generator to produce a haptic effect that simulates firing the firearm.

5. The haptic effect system of claim 4, wherein the firing signals also cause the haptic effect generator to produce a haptic effect that simulates loading a round of ammunition from a magazine.

6. The haptic effect system of claim 4, wherein the firing signals also cause the haptic effect generator to produce a haptic effect that simulates what would occur when a last round of ammunition has been fired.

7. The haptic effect system of claim 1, wherein the haptic effect generator is operatively coupled to a cocking mechanism of the firearm, and wherein the haptic effect generator is configured to apply a force to the cocking mechanism when a user actuates the cocking mechanism to prepare the firearm for simulation firing.

8. The haptic effect system of claim 7, wherein the force applied to the cocking mechanism by the haptic effect generator causes the user to experience cocking forces that approximate cocking forces the user would experience when actuating the cocking mechanism to prepare the firearm for live firing with actual ammunition.

9. The haptic effect system of claim 1, further comprising a cocking simulator that is configured to be mounted to a firearm and to apply a cocking force to a cocking mechanism of the firearm.

10. The haptic effect system of claim 9, wherein the cocking simulator is operatively coupled to the controller and to the cocking mechanism of the firearm, wherein the cocking simulator receives cocking force signals from the controller that cause the cocking simulator to apply a cocking force to the cocking mechanism.

11. The haptic effect system of claim 1, wherein the trigger interface applies a force to the trigger of the firearm.

12. The haptic effect system of claim 11, wherein the trigger interface applies a force to the trigger mechanism of the firearm such that a user will experience trigger pull forces that are substantially the same as trigger pull forces the user would experience when firing live ammunition.

13. The haptic effect system of claim 12, wherein the trigger signals cause the trigger interface to apply a force to the trigger mechanism of the firearm such that a user will experience trigger pull forces that are substantially the same as trigger pull forces the user would experience when firing live ammunition in a burst fire mode.

14. The haptic effect system of claim 12, wherein the trigger signals cause the trigger interface to apply a force to the trigger mechanism of the firearm such that a user will experience trigger pull forces that are substantially the same as trigger pull forces the user would experience when firing live ammunition in an automatic fire mode.

15. The haptic effect system of claim 1, wherein the trigger interface comprises an ammunition simulator that is configured to occupy a space within the firearm that would normally be occupied by a round of ammunition that is ready to be fired by the firearm, and wherein the ammunition simulator causes the trigger interface to generate a trigger signal when a hammer of the firearm contacts the ammunition simulator.

16. The haptic effect system of claim 1, further comprising a sensor that is configured to be removably attached to the firearm and that is operatively coupled to the controller, wherein the sensor generates a signal that is indicative of a position of an internal mechanism of the firearm.

17. The haptic effect system of claim 16, wherein the sensor is a time-of-flight sensor that includes an electromagnetic radiation emitter and an electromagnetic radiation detector.

18. The haptic effect system of claim 1, further comprising an inertial sensor that is configured to be removably attached to the firearm and that is operatively coupled to the controller, wherein the inertial sensor generates a signal that is indicative of movements of the firearm.

19. The haptic effect system of claim 1, wherein the controller is configured to control the haptic effect generator such that the haptic effect generator generates a haptic effect that simulates a malfunction of the firearm.

20. The haptic effect system of claim 1, further comprising a user interface that is operatively coupled to the controller, wherein the user interface allows a user to provide input that is used by the controller to control the haptic effect generated by the haptic effect generator.
